(19) United States
(12) Patent Application Publication
(10) Pub. No.: US 2004/0201175 A1
(43) Pub. Date: Oct. 14, 2004

(54) Drive seal

(76) Inventors: Michael Buchmann, Kissing (DE); Hans-Henning Zutz, Wermelskirchen (DE); Peter Wittka, Kissing (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/754,333

(22) Filed: Jan. 9, 2004

(30) Foreign Application Priority Data
Jan. 10, 2003 (DE) 103 00 567.6

(51) Int. Cl. F16J 15/34

(52) U.S. Cl. 277/358

(57) ABSTRACT

A drive seal includes at least one metal ring having an annular running surface onto which is applied a thermally sprayed hard metal protective wear coating. The hard metal wear coating is coated by a sliding lacquer layer containing solid lubricants and which is softer compared to the hard metal wear layer.

### This application claims the benefit of German patent application No. 103 00 567.6, filed Jan. 10, 2003.

### BACKGROUND OF THE INVENTION

1. Technical Field

The invention concerns a drive seal having a metal ring (sliding and/or counter ring) whose running surface area is covered with a protective coating against wear and tear.

2. Related Art

In U.S. Pat. No. 4,505,485 a drive seal has been made known, whose running surface area is at least partly covered by a protective coating against wear and tear, whereby a chromium, tungsten, vanadium, titanium, niobium, cobalt, molybdenum coating is deposited onto the running surface area, in combination with carbides or carbon where necessary. The coating is applied in a spiral pattern and is hardened by re-fusing.

In U.S. Pat. No. 3,086,782 a drive seal is described, consisting of uncoiled tin, and whose running surface area is covered by a protective coating against wear and tear. The ultra-thin protective coating against wear and tear is to be applied after the running surface area has been lapped.

In DE 197 00 835, there is disclosed a compound layer, as well as a process for the creation of a self-lubricating compound layer and self-lubricating parts made thereof. The powder blend consists of between 25 and 75 percent by volume ceramics powder containing carbide; between 5 and 50 percent by volume metal powder chosen from a group consisting of nickel, chromium and combinations thereof; and between 2 and 25 percent by volume solid lubrication powder chosen from a group consisting of molybdenum disulfide, lead oxide, silver and titanium oxide. The compound layer is applied to the part via a process of high-speed flame spraying, so that a self-lubricating layer is formed. Preferred applications include piston rings and cylinder sleeves.

Today's metal drive seals (in particular, high-performance cast materials containing carbide) must be expensively machined in the running surface area via a process of trapezoidal grinding, honing, and the like. Once applied, the protective coatings against wear and tear have to be subsequently machined by grinding, polishing and the like, in order to insure that the drive seal, in its operating state, will have the required tightness. Often a lubricant must be added in order to achieve the prescribed tribological properties. Apart from this costly type of manufacture, these drive seals may only be used for low-r.p.m. (revolutions-per-minute) operations.

### SUMMARY OF THE INVENTION

The present invention has the objective of improving the tribological properties of drive seals while at the same time permitting higher-r.p.m. operations. Furthermore, it seeks to avoid, as much as possible, any subsequent machining of the running surfaces, while at the same time using cost-efficient base materials.

The hard material layer is based on materials such as oxide ceramics, cermet and/or hard metals.

The sliding lacquer layer may be made out of PTFE or graphite-containing materials. Other appropriate types of sliding lacquers may also be used.

This sliding lacquer layer may also contain solid lubricants such as molybdenum disulfide, titanium oxide, boron nitride or the like.

The invention also meets the goal by specifying a method for creating a protective coating against wear and tear on the running surface of the metal drive seal, namely by applying a layer of hard material onto the running surface via a process of thermal spraying. The surface of the thermally sprayed layer is then sealed with a softer, sliding lacquer layer in which solid lubricants are embedded.

What is proposed is that a sealed hard metal coating be applied to the running surface of drive seals made of cast iron or light metal. The invention optimizes the tribological operating properties of the drive seals through the use of sliding lacquer systems that, when applied to thermally sprayed coating materials, reduce friction and wear and tear. Due to the good tribological properties, a much higher through-put can be achieved than before (e.g. higher speeds, insufficient lubrication states, etc.,) may now be realized. Lubrication of the sealing area is usually not needed. Furthermore, cost savings can be realized by using cost efficient base materials (cast iron or light metal) rather than the previously used high performance carbide containing cast materials. In addition, the current cost intensive machining of the running surface area (trapezoidal grinding or honing) is obsolete. Furthermore, subsequent machining (grinding/polishing) of the thermally sprayed hard material layer is not needed. The required tightness of the drive's running surface is realized in the beginning by the relatively soft sliding lacquer layer. The thermally sprayed hard material layer is run-in during operation by constant abrasion of the sliding lacquer layer.

The hard material layer may be applied to the running surface by known thermal spraying processes (APS, HVOF, electric arc wire, wire flame or powder flame procedure).

### THE DRAWINGS

The subject of the invention is shown in the drawing using a design example and is described as follows. It is shown in:

FIG. 1 Example of a drive seal;

FIG. 2 Drawing of the sliding ring of FIG. 1, containing a wear and tear resistant sealed hard material layer.

### DETAILED DESCRIPTION

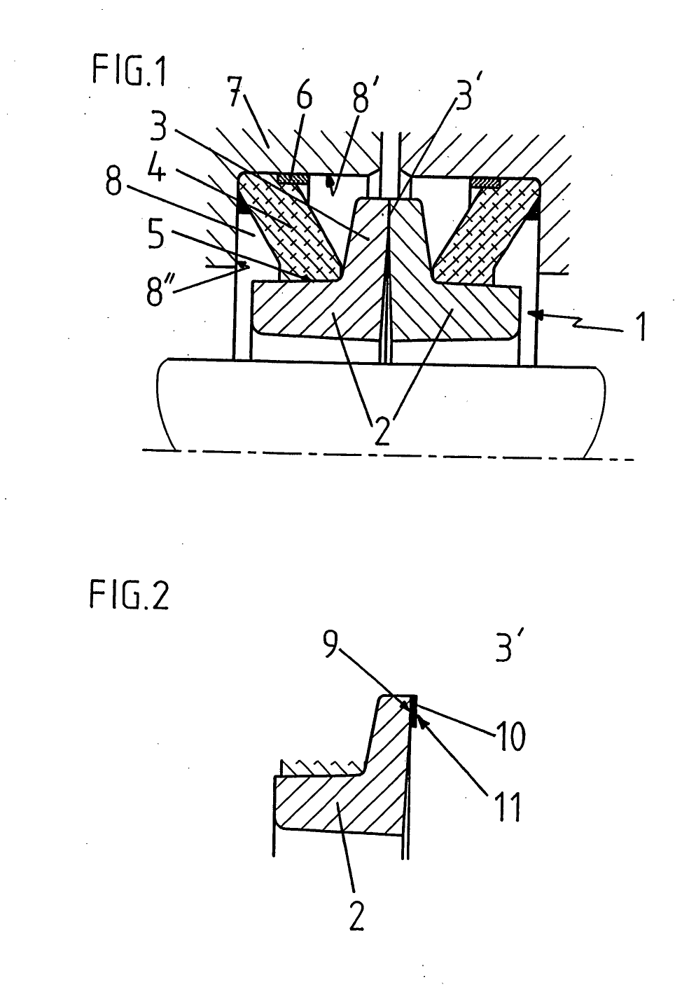

FIG. 1 shows a drive seal 1, in this example having two geometrically identical sliding and counter rings 2, so that only a sliding ring 2 is referred to hereinafter. Sliding ring 2 shows an angular shaped cross section. The sealing leg 3 of the sliding rings 2 form a dynamic sealing area 3′. Sliding ring 2 has a cylinder shaped circumferential area 5 in order to accept a trapezoidal sealing body 4. The sealing body 4 includes a secondary seal 6. Sliding ring 2, equipped with the sealing body 4, 6 is inserted into the drive element to be sealed 7 axially, so that it is pushed into a bore provided there in axial direction using a tool (not shown), while any wedging in the bore is impossible to occur. Within bore 8, the sealing body is supported by the radial 8′ as well as by the axial area 8″ of the drive element 7.

FIG. 2 shows a partial view of a sliding ring pursuant to FIG. 1. The dynamic sealing area 3′ can be seen, which is formed by a running surface 9, onto which a hard material layer 10 is applied by thermal spraying, which in this example is made out of oxide ceramics. The surface 11 of the thermally sprayed layer 10 is then sealed using a sliding lacquer layer, which in this example contains PTFE and into which solid lubricants are embedded, e.g. based on molybdenum disulfide. Due to the design of this sealed, thermally sprayed hard material layer 10, no subsequent machining such as grinding, polishing or the like of the thermally sprayed hard material layer is necessary to achieve an adequate sealing surface. The thermally sprayed hard material layer 10 is run-in during operation by constant abrasion of the sliding lacquer layer.

1. A drive seal comprising at least one metal drive ring having an annular running surface positionable in operation to confront an associated running surface of an adjacent metal ring, and including a thermally sprayed protective wear coating of hard metal formed on said running surface.

2. The drive seal of claim 1, including a relatively softer sliding lacquer layer having solid lubricants applied to said thermally sprayed protective wear coating.

3. The drive seal of claim 2 wherein said thermally sprayed protective wear coating includes oxide ceramics.

4. The drive seal of claim 2 wherein said thermally sprayed protective wear coating includes cermets.

5. The drive seal of claim 2 wherein said sliding lacquer layer contains PTFE.

6. The drive seal of claim 2 wherein said sliding lacquer layer contains graphite.

7. The drive seal of claim 2 wherein said solid lubricants comprises at least one material selected form the group consisting of: molybdenum disulfide, titanium oxide and boron nitride.

8. The drive seal of claim 1 wherein said at least one ring is fabricated of cast iron.

9. The drive seal of claim 1 wherein said at least one ring is fabricated of a light metal.

10. The drive seal of claim 1 including a pair of said metal rings having their respective running surfaces confronting one another.

11. The drive seal of claim 10 wherein said rings are identical in construction and a mirror image of one another.

12. The drive seal of claim 10 wherein said thermally sprayed protective wear coatings of said pair of said metal rings are identical.

13. A process for the manufacture of a drive seal, comprising:
preparing at least one metal drive ring having an annular running surface; and
applying a protective wear coating of hard metal to the running surface by thermal spraying.

14. The process of claim 13 including applying a relatively softer sliding layer having solid lubricants to the thermally sprayed protective wear coating.

15. The process of claim 14 wherein the sliding layer is formulated to include at least one of PTFE and graphite.

16. The process of claim 14 wherein the solid lubricants are selected as at least one material from the group consisting of molybdenum disulfide, titanium oxide and boron nitride.

17. The process of claim 13 wherein the at least one metal ring is fabricated of cast iron or light metal.

18. The process of claim 13 including preparing a pair of such metal rings and arranging them with their respective running surfaces in confronting relation to one another.

19. A drive seal, consisting of a metal sliding and/or counter ring having a running surface and a wear and tear protective coating in the area of its running surface wherein the wear and tear protective coating is formed by a thermally sprayed hard metal layer.

20. A drive seal according to claim 19, wherein the hard material layer is coated by a softer sliding lacquer layer containing solid lubricants.

21. A drive seal according to claim 19, wherein the hard material layer contains oxide ceramics, cermet and/or hard metal.

22. A drive seal according to claim 20, wherein the sliding lacquer layer contains PTFE or graphite.

23. A drive seal according to claim 19, the solid lubricants are selected at least one material from the group consisting of: molybdenum disulfide, titanium oxide and boron nitride.

24. A drive seal according to claim 19, wherein the sliding and/or counter ring is made out of cast iron or a light metal.

25. A process for the manufacture of a wear and tear protective coating on the running surface of a drive seal containing a metal sliding and/or counter ring, including applying a hard material layer onto the running surface by thermal spraying.

26. The process of claim 25, including sealing the hard metal layer with a sliding lacquer layer, which is softer compared to the hard material layer and into which solid lubricants are embedded.
